(19) United States
(12) Patent Application Publication
(10) Pub. No.: US 2007/0232316 A1
(43) Pub. Date: Oct. 4, 2007

(54) System and method for secure network browsing

(75) Inventors: Kenneth J. Reda, San Juan Capistrano, CA (US); Christopher A. Akins, Griffin, GA (US)

Correspondence Address: CROWELL & MORING LLP;INTELLECTUAL PROPERTY GROUP, P.O. BOX 14300, WASHINGTON, DC, 20044-4300, US

(73) Assignee: Seamless Skyy-Fl, Inc.

(21) Appl. No.: 11/731,273

(22) Filed: Mar. 30, 2007

Related U.S. Application Data
(60) Provisional application No. 60/787,736, filed on Mar. 30, 2006.

(51) Int. Cl. H04Q 7/20

(52) U.S. Cl. 455/445

(57) ABSTRACT

A virtual network adapter or module intercepts an outgoing network resource request from a browser application and encrypts the request before transmitting it to a proxy server over a public network connection. In one embodiment, the proxy server decrypts the request and communicates with a target server to receive the requested network resource. In another embodiment, the proxy server encrypts the requested network resource before transmitting it back to the virtual network adapter or module over the public network connection.

### CROSS-REFERENCE TO RELATED APPLICATION

This application claims the benefit of U.S. Provisional Application No. 60/787,736, filed on Mar. 30, 2006, which is hereby fully incorporated by reference.

### 1. FIELD OF THE INVENTION

The present invention relates to network browsing, and more particularly to systems and methods for secure network browsing.

### 2. BACKGROUND

Internet hotspots are defined generally as specific geographic location in which a wireless access point (e.g., a wi-fi hotspot) provides public wireless network services to mobile visitors through a wireless local-area network (WLAN). Hotspots are often located in heavily populated places such as airports, train stations, libraries, marinas, conventions centers and hotels. The problem is that as more and more people make use of their favorite public Wi-Fi hotspot, hackers lie in wait, anxious to exploit the vast security vulnerabilities inherent in wireless communications.

One potential security vulnerability is commonly referred to as the ‘evil twin.’ An ‘evil twin’ is a hacker-operated hotspot designed to deceive users into believing it is a legitimate public hotspot by mimicking the legitimate public hotspot's network name and other particulars. Once the user has connected to the illegitimate hotspot, the hacker is free to capture all data sent to and from the user's computer. Hackers operating an ‘evil twin’ network have even been able to mimic login pages for popular email and banking sites, and then capture user's most valuable login information.

A standard protection against this type of attack is to only use public hotspots that provide an SSL-encrypted login connection which has been certified as legitimate by a trusted third-party. The problem with this, however, is that many Internet websites are not equipped with SSL capabilities. As such, user communications to non-SSL websites are still vulnerable.

Securing the wireless hotspot at the WLAN-level is also not very effective. Existing wireless security standards that use secret network keys (WEP, WPA) are virtually useless at public hotspots since one user's network key can be used by a hacker to decrypt all network communications. As such, virtually all public hotspots disable WEP and WPA to provide a hassle free login for users. This means data which is not encrypted as it travels through the air can be easily read by a hacker using what is known as a man-in-the-middle (MITM) attack.

As such, there is a need in the art for a system and method of securing all communications from a user to a target website where the user is accessing a public wireless network, such as a wi-fi hotspot.

### SUMMARY OF THE INVENTION

Disclosed and claimed herein are methods, servers and computer program products for secure communication. In one embodiment, a method comprises intercepting a network resource request from a user of a user computer connected to a network over a wireless network connection, encrypting the network resource request, and transmitting the encrypted network resource request over the wireless network to a proxy server. The method further includes receiving an encrypted network resource from the proxy server over the wireless network connection, decrypting the encrypted network resource, and providing the decrypted network resource to the user responsive to the network resource request.

In another embodiment, a proxy server includes a network interface configured to connect the server to a user computer over a wireless network connection. The proxy server further includes a processor, electrically coupled to the network interface, and a memory electrically coupled to the processor, where the memory contains processor-executable instructions. In one embodiment, the processor-executable instructions are to receive, over the wireless network connection, an encrypted network resource request from a virtual network adapter module of the user computer, decrypt the encrypted network resource request using a public key from a public/private encryption key pair of a user of the user computer, and transmit the decrypted network resource request to a target network server. The processor-executable instructions are further to cause the server to receive the requested network resource from the target network server in response to said decrypted network resource request, encrypt the requested network resource using said public key, and transmit, over the wireless network connection, the encrypted requested network resource to the virtual network adapter module of the user computer.

Other aspects, features, and techniques of the invention will be apparent to one skilled in the relevant art in view of the following description of the exemplary embodiments of the invention

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 is a system diagram of one embodiment of a network for implementing out one or more aspects of the invention;

FIG. 2 is a signal flow diagram according to one embodiment of the invention;

FIG. 3 is one embodiment of a process for carrying out one or more aspects of the invention; and

FIG. 4 is another embodiment of a process for carrying out one or more aspects of the invention.

### DETAILED DESCRIPTION OF EXEMPLARY EMBODIMENTS

One aspect of the invention relates to providing a secure method for browsing a network, such as the Internet, over a wireless network connection. In one embodiment, a user computer runs a virtual network adapter or module that captures or intercepts outgoing network resource requests, such as Web page requests, from a browser application also executing on the user computer. Once a network resource request is captured or otherwise intercepted, the request may be encrypted using, for example, a public/private key encryption scheme. In one embodiment, the encryption process may also tag the request with the a user ID and/or public key. Either or both of the user ID and public key may have been provided to the user during a previous registration process during which the user registered with a proxy server, such as a peer-to-peer (P2P) server.

Once encrypted and tagged, the virtual network adapter/module may send out the request over the wireless network connection to a proxy server. The proxy server may then use the included user ID and/or public key to both decrypt the request and verify the user's identity. Once decrypted, the URL request is then handed off as a normal URL request. Thereafter, the proxy server may receive, in response to this request, the target Web page. The requested Web page may then be encrypted using the user's public key and sent to the originating user computer. Once the user computer received the encrypted requested Web page, the virtual network adapter/module will intercept it and decrypt the page using the user's private key. In this fashion, a user may securely browse a network using an otherwise insecure wireless network connection.

In accordance with the practices of persons skilled in the art of computer programming, the invention is described below with reference to symbolic representations of operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations such as in system memory, as well as other processing of signals. The memory locations where data bits are maintained are physical locations that have particular electrical, magnetic, optical, or organic properties corresponding to the data bits. Thus, the term “server” is understood to include any electronic device that contains a processor, such as a central processing unit.

When implemented in software, the elements of the invention are essentially the code segments to perform the necessary tasks. The program or code segments can be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

As discussed herein, a “computer” or “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. In addition, a “communication link” refers to the medium or channel of communication. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, etc., and combinations thereof.

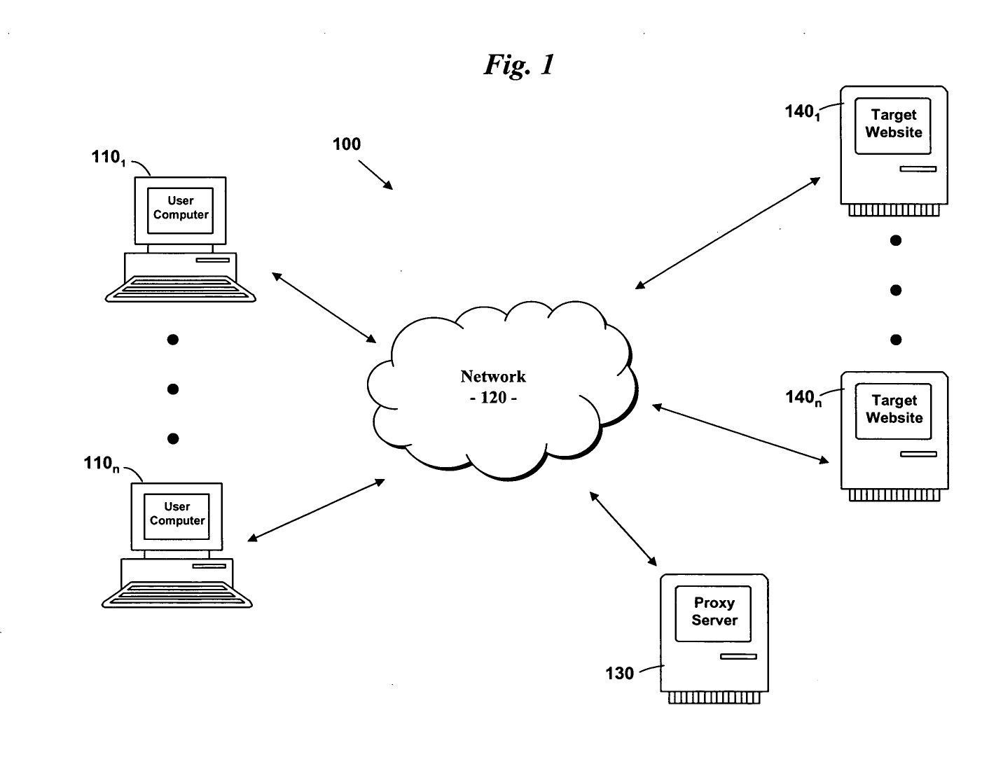

Referring now to the figures, FIG. 1 depicts one embodiment of a communication system 100 in which a plurality of user computers 110₁-110ₙ (“110”) are connected to a network 120 (e.g., Internet). In one embodiment, at least one of the user computers accesses the network 120 via a public wireless network connection, such as a WLAN. In certain embodiments, user computers 110 may include a browser application usable to access one or more target websites 140₁-140ₙ (“140”) using corresponding, for example, uniform resource locator (URL) information. In one embodiment, the target websites do not recognize secure sockets layer (SSL) network sessions.

System 100 further includes a proxy server 130, which is also connected to network 120 and able to communication with user computers 120 and target websites 140. As is known in the art, the target websites 140 may be comprised of one or more servers that execute computer-executable instructions for generating and displaying Web pages for viewing by the user computers 120. As will be described in detail below, requests from a user computer 120 to access one of the target websites 140 may be directed to and processed by the proxy server 130. In one embodiment, the user computer 120 may encrypt any such requests prior to sending it out over the network 120.

Proxy server 130 may be a P2P server, such as the P2P server system described in co-pending U.S. patent application Ser. No. 11/349,966, entitled “System and Method for Providing Peer-to-Peer Communication,” filed on Feb. 2, 2006, assigned to the assignee hereof, and which is hereby fully incorporated by reference. As such, the users of user computers 110 may be P2P community members that have previously registered with the proxy server 130.

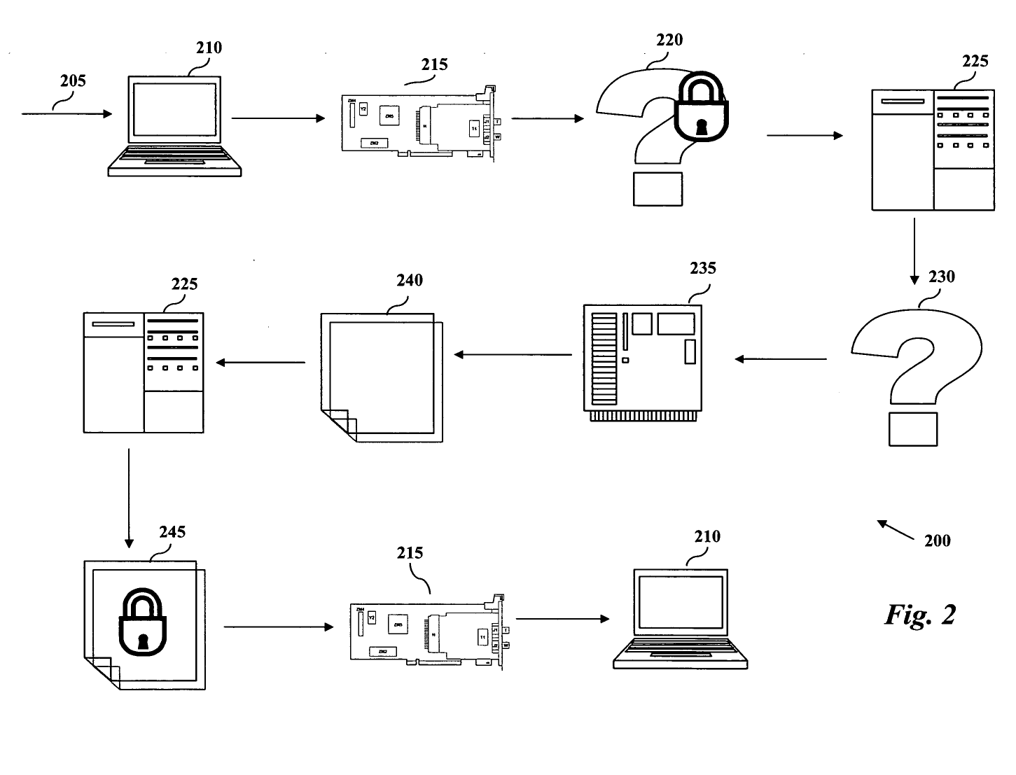

Referring to FIG. 2, depicted is a diagram of the signal flow 200 in accordance with one embodiment of the invention. As shown, the signal flow 200 begins with a user providing a request 205 to view a particular network resource, such as a webpage. In certain embodiment, the request may be entered into a browser application executing on user computer 210. In one embodiment, the user computer 210 may be connected to a public network (e.g., network 120), as described above with reference to FIG. 1. The user computer 210 may also have established a wireless connection to the network 120, which in one embodiment is the Internet. This wireless connection may be a wi-fi hotspot, or any other public wireless Local Area Network or Wide Area Network (LAN/WAN).

The browser application executing on the user computer 210 may receive the request in the form of a URL. Prior to the request being sent out over the wireless connection, the virtual network adapter 215 may intercept the request. In one embodiment, all outgoing network resource requests may be automatically intercepted by the virtual network adapter 215. In one embodiment, the virtual network adapter 215 may be comprised of one or more software modules also executing on the user computer 210. For example, the virtual network adapter may be a virtual network module that is implemented as a plug-in to the browser or as an Application Programming Interface (API). Alternatively, the virtual network adapter 215 may be implemented as hardware (e.g., a system device) or a combination of hardware and software.

Continuing to refer to FIG. 2, the virtual network adaptor 215 may then encrypt the request 205 that it receives from the user computer 210 to generate encrypted network resource request 220. In one embodiment, the request 205 may be encrypted using the user's private key of a public/private key pair generated according to a known encryption scheme, such as Rijndael/AES or RSA encryption. In another embodiment, the virtual network adapter 215 may also tag the request 205 with user identification information (e.g., P2P ID) and the user's public key. As will be described in more detail below, this information may be used by a proxy server to identify the source of the request 205 and how to encode the actual network resource (e.g., Web page) being requested.

The encrypted network resource request 220 (e.g., encrypted URL) may then be safely sent out over the wireless network to which the user computer 210 is connected. The fact that the data is encrypted prior to even reaching the wireless network may preclude hackers from being able to intercept sensitive user information.

At this point, rather than the encrypted network resource request 220 being processed in the normal course, the request 220 may instead be provided to the proxy server 225 over the network (e.g., Internet). The encrypted network resource request 220 may then be decrypted by the proxy server 225 using a corresponding decryption key for the subject user. Note that both the user's public key and the user's ID (e.g., P2P ID) may be used to verify the identity of the user sending the encrypted network resource request 220. In one embodiment, the user may have pre-registered with the proxy server to obtain a public key and/or P2P ID using, for example, the registration process described in the previously-incorporated co-pending U.S. patent application Ser. No. 11/349,966.

Once the request is decrypted and the identity of the subject user optionally verified, the proxy server 235 may then make transmit the decrypted network resource request 230 as a standard network resource request. In certain embodiments, the proxy server 235 may make the request on behalf of the subject user. In one embodiment, the proxy server 225 may be situated on a secure network which is not susceptible to MITM attacks or neighbor eavesdropping.

In one embodiment, the decrypted network resource request 230 is received by the target server 235 which is associated with or otherwise generates the requested network resource. In one embodiment, the target server 235 may not recognize SSL network sessions or communications. In certain embodiments, the target server 235 may respond to the decrypted network resource request 230 with the actual requested network resource 240, which in one embodiment is a Web page. That is, the network resource 240 may be provided by the target server 235 back to the proxy server 225, as shown in FIG. 2. Upon receiving the network resource 240, the proxy server 225 may then encrypt network resource 240 using, for example, the subject user's public encryption key. In certain embodiments, the subject user's public encryption key may have been provided as part of the original request. In addition, the user ID may be used to verify and authenticate the user's public key. Alternatively, the public key may be compared to a key stored at the proxy server 225 a user registration process.

Continuing to refer to FIG. 2, the encrypted requested network resource 245 may then safely travel over the public wireless network back to the subject user. That is, all data that has traveled over the public wireless network to which the subject user is connected has been encrypted and secure. To that end, encrypted requested network resource 245 is received by the aforementioned virtual network adapter 215, which may in decodes the encrypted requested network resource 245 using, for example, the subject user's private key. Thereafter, the requested network resource (e.g., Web page) may be displayed in the browser application executing on the user computer 210 without any data ever having been wirelessly transmitted in an insecure form.

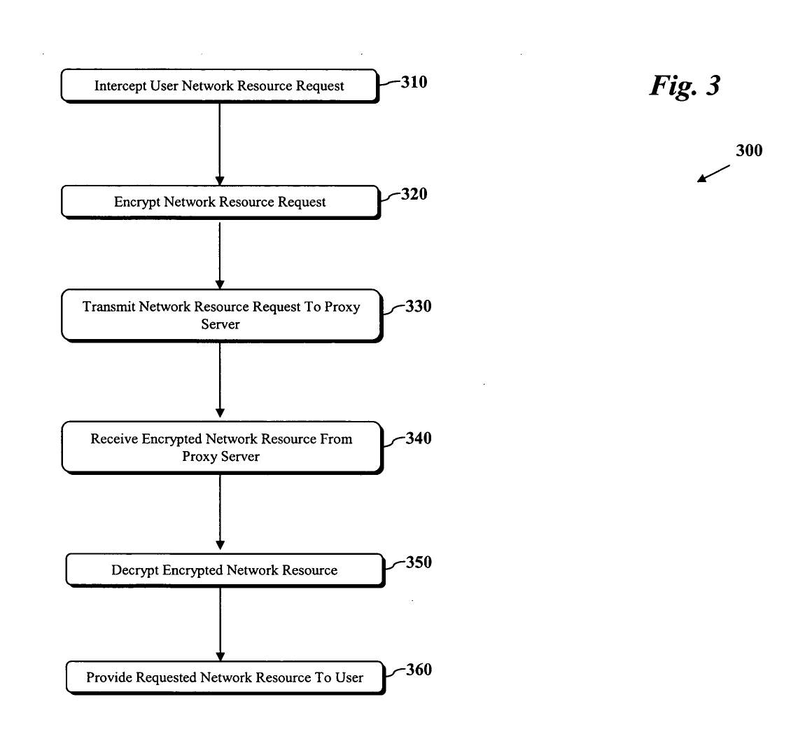

Referring now to FIG. 3, depicted is one embodiment of a process 300 to be performed by a virtual network adapter (e.g., adapter 215) in accordance with the principles of the invention. As previously mentioned, the virtual network adapter may be implemented using software, hardware or a combination thereof.

Process 300 begins at block 310 where the virtual network adapter intercepts the network resource request provided by a subject user. In certain embodiments, the request may have been entered into a browser application executing on a user computer (e.g., user computer 110) that is connected to a public wireless network (e.g., network 120), as described above with reference to FIG. 1. In certain embodiments, the interception operation of block 310 may occur as the browser application attempts to send the request out over the public wireless connection.

Process 300 continues to block 320 where the virtual network adapter the virtual network adaptor may then encrypt the request that was intercepted above at block 310. In one embodiment, this encryption may be accomplished using the user's private key of a public/private key pair generated according to a known encryption scheme, such as Rijndael/AES or RSA encryption. In another embodiment, the encryption may include tagging the intercepted request with user identification information (e.g., P2P ID) as well.

Once the network resource request has been encrypted, process 300 may then continue to block 330 where the encrypted network resource request is transmitted out over the public wireless connection to a proxy server (e.g., proxy server 130).

Thereafter, process 300 continues to block 340 where an encrypted form of the requested network resource is received from the proxy server. Thereafter, the encrypted network resource may then be decrypted using, for example, the subject user's private key (block 350). The decrypted network resource may then be provided to the subject user at block 360, which in one embodiment may be in the form of displaying the requested Webpage in a browser application.

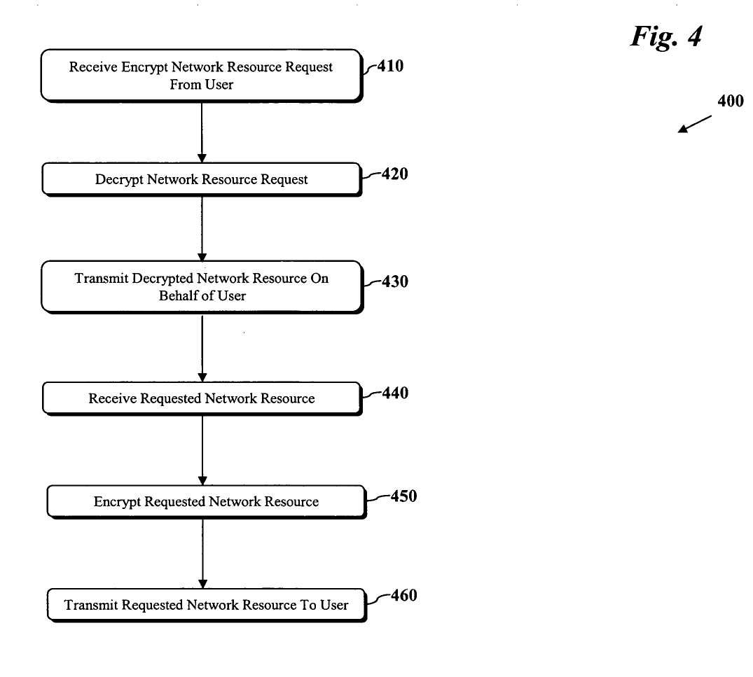

Referring now to FIG. 4, depicted is one embodiment of a process 400 to be performed by a proxy server (e.g., proxy server 130) in accordance with the principles of the invention. As previously mentioned, the proxy server may be in communication with a subject user computer (e.g., user computer 110) over a network connection, as well as able to communication with a plurality of target network resources (e.g., target websites 140).

Process 400 begins at block 410 where an encrypted network resource request is received. In one embodiment, the network resource request may have been encrypted by a virtual network adapted executing on a subject user computer and performing process 300 of FIG. 3.

Once an encrypted network resource request has been received at block 410, process 400 may continue to block 420 where the request may be decrypted. In one embodiment, the request may have been encrypted using a subject user's private key. The request may have optionally been tagged with a user ID (e.g., P2P ID) specific to the subject user. Thus, in one embodiment, the decryption operation of block 420 may be performed using a public key of the subject user after (or before) the user has been identified using the included user ID. As previously mentioned, the user may have pre-registered with the proxy server to obtain a public key and/or P2P ID using, for example, the registration process described in the previously-incorporated co-pending U.S. patent application Ser. No. 11/349,966.

Once the request has been decrypted at block 420, process 400 may continue to block 430 where the decrypted network resource request may be transmitted as a standard network resource request on behalf of the subject user. In one embodiment, decrypted network resource request may be sent on a secure network connection. In any event, the decrypted network resource request may be sent to a target server which is associated with or otherwise generates the requested network resource.

Process 400 continues to block 440 where the actual requested network resource may be received from the target server, for example. In one embodiment, the network resource does not recognize a secure network connection (e.g., SSL). Upon receiving the network resource at block 440, the network resource may then be encrypted using, for example, the subject user's public encryption key (block 450).

Thereafter, the encrypted network resource may be transmitted to the subject user at block 460. In one embodiment, a virtual network adapter may intercept the encrypted network resource, as described above with reference to FIG. 3. Thereafter, the requested network resource (e.g., Web page) may be displayed by a browser application to the subject user without any data ever having been wirelessly transmitted in an insecure form, despite the fact that the network resource itself may not be able to establish a secure network connection (e.g., SSL).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A method for secure communication, the method comprising:
intercepting a network resource request from a user of a user computer connected to a network over a wireless network connection;
encrypting the network resource request;
transmitting the encrypted network resource request over the wireless network to a proxy server;
receiving an encrypted network resource from the proxy server over the wireless network connection;
decrypting the encrypted network resource; and
providing the decrypted network resource to the user responsive to the network resource request.

2. The method of claim 1, wherein intercepting the network resource request comprises intercepting the network resource request from a browser application executing on the user computer before being sent to the wireless network connection.

3. The method of claim 1, wherein the wireless network connection is an unsecured network connection, and wherein the network resource request relates to a network resource that does not recognize secure network sessions.

4. The method of claim 1, wherein encrypting comprises encrypting the network resource request using a private key from a public/private encryption key pair of the user.

5. The method of claim 4, wherein encrypting further comprises tagging the network resource request with a user identification for said user.

6. The method of claim 4, wherein decrypting comprises decrypting the encrypted network resource using a public key from the public/private encryption key pair of the user.

7. The method of claim 1, wherein providing the decrypted network resource comprises providing the decrypted network resource to a browser application executing on the user computer.

8. A system for secure communication comprising:
a network interface to establish a wireless network connection;
a user input to receive a network resource request;
a browser application configured to process the network resource request; and
a virtual network adapter module configured to:
intercept the network resource request from the browser application,
encrypt the network resource request,
transmit the encrypted network resource request over the wireless network connection to a proxy server,
receive an encrypted network resource from the proxy server over the wireless network connection,
decrypt the encrypted network resource, and
provide the decrypted network resource to the browser application responsive to the network resource request.

9. The system of claim 8, wherein the wireless network connection is an unsecured network connection, and wherein the network resource request relates to a network resource that does not recognize secure network sessions.

10. The system of claim 8, wherein the virtual network adapter module is configured to encrypt the network resource request using a private key from a public/private encryption key pair of the user.

11. The system of claim 10, wherein the virtual network adapter module is further configured to tag the network resource request with a user identification for said user.

12. The system of claim 10, wherein the virtual network adapter module is configured to decrypt the encrypted network resource using a public key from the public/private encryption key pair of the user.

13. A proxy server comprising:
a network interface configured to connect the server to a user computer over a wireless network connection;
a processor electrically coupled to the network interface; and
a memory electrically coupled to the processor, the memory containing processor-executable instructions to cause the proxy server to:
receive, over the wireless network connection, an encrypted network resource request from a virtual network adapter module of the user computer,
decrypt the encrypted network resource request using a public key from a public/private encryption key pair of a user of the user computer,
transmit the decrypted network resource request to a target network server,
receive the requested network resource from the target network server in response to said decrypted network resource request,
encrypt the requested network resource using said public key, and
transmit, over the wireless network connection, the encrypted requested network resource to the virtual network adapter module of the user computer.

14. The proxy server of claim 13, wherein the wireless network connection is an unsecured network connection, and wherein the target network server does not recognize secure network sessions.

15. The proxy server of claim 13, wherein the memory further contains processor-executable instructions to identify the user based on a user identification included in said encrypted network resource request.

16. A computer program product, comprising:
a processor readable medium having processor executable code embodied therein to enable secure communication, the processor readable medium having:
processor executable program code to intercept a network resource request from a user of a user computer connected to a network over a wireless network connection;
processor executable program code to encrypt the network resource request;
processor executable program code to transmit the encrypted network resource request over the wireless network to a proxy server;
processor executable program code to receive an encrypted network resource from the proxy server over the wireless network connection;
processor executable program code to decrypt the encrypted network resource; and
processor executable program code to provide the decrypted network resource to the user responsive to the network resource request.

17. The computer program product of claim 16, wherein the processor executable program code to intercept comprises processor executable program code to intercept the network resource request from a browser application executing on the user computer before being sent to the wireless network connection.

18. The computer program product of claim 16, wherein the wireless network connection is an unsecured network connection, and wherein the network resource request relates to a network resource that does not recognize secure network sessions.

19. The computer program product of claim 16, wherein the processor executable program code to encrypt comprises processor executable program code to encrypt the network resource request using a private key from a public/private encryption key pair of the user.

20. The computer program product of claim 19, further comprising processor executable program code to tag the network resource request with a user identification for said user.

21. The computer program product of claim 19, wherein the processor executable program code to decrypt comprises processor executable program code to decrypt the encrypted network resource using a public key from the public/private encryption key pair of the user.

22. The computer program product of claim 16, wherein the processor executable program code to provide comprises processor executable program code to provide the decrypted network resource to a browser application executing on the user computer.
